(19) United States
(12) Patent Application Publication
(10) Pub. No.: US 2025/0229277 A1
(43) Pub. Date: Jul. 17, 2025

(54) Garden Hose Nozzle

(71) Applicant: SHIN TAI SPURT WATER OF THE GARDEN TOOLS CO., LTD., Changhua County (TW)

(72) Inventor: Chin-Yuan Chen, Changhua County (TW)

(73) Assignee: SHIN TAI SPURT WATER OF THE GARDEN TOOLS CO., LTD., Changhua County (TW)

(21) Appl. No.: 18/411,541

(22) Filed: Jan. 12, 2024

(51) Int. Cl. B05B 1/14; B05B 12/00

(52) U.S. Cl. CPC B05B 1/14; B05B 12/002

(57) ABSTRACT

A garden hose nozzle includes a hose nozzle, wherein the hose nozzle is made of injection molding and has a body part, one end of the body part is connected to a water spray part for spraying water, the other end of the body part is equipped with a water supply part used to supply water. The surfaces of the body part, the water spray part, and the water supply part are covered with at least one wrapping layer for protection and holding. The wrapping layer is composed of a thermoplastic polyolefin, a polyethylene, and a cork. The proportions of the thermoplastic polyolefin, the polyethylene, and the cork in the wrapping layer are 15%, 54%, and 30% respectively.

### BACKGROUND OF THE INVENTION

### Field of the Invention

The present invention relates to a garden hose nozzle or a gardening water spray gun, particularly to a garden hose nozzle or a gardening water spray gun that is conducive to recycling.

### Description of the Related Art

A garden hose nozzle or a gardening water spray gun is a tool used with a water hose to spray water over a wide range to water plants. The garden hose nozzle adjusts the spraying range and intensity to ensure that the plants are properly watered, and at the same time, it is more efficient to save water than simply using the water hose.

Since garden hose nozzles are widely used in the field of gardening work, more and more waste is generated in the consumption process. In the modern era when the earth's resources are gradually scarce, it is quite inconsistent with sustainability and environmental protection. In addition, the relevant laws and regulations around the world have also begun to regulate that packaging and goods with less than 70% recycled content for consumption should not enter the market, and subsequent recycling and reuse should be considered in product manufacturing and design.

For the mass production and improvement of garden hose nozzles or gardening water spray guns, the nozzle body may be mass-produced first, and then the wrapping material is wrapped on the body for the user to hold. The advantage of this is that the nozzle body can be unified mass production, and the wrapping materials can be subsequently selected and replaced based on users' feel and material properties. In addition, when these wrapping materials are broken, they can be easily recycled separately from the nozzle body.

Cork is the outer protective tissue of woody plants. The carbon footprint of its collection and use is smaller than that of plastic. Cork collection does not require cutting down trees, so it is sustainable and environmentally friendly, and can also be recycled in actual use. It is reusable and has a good touch feel, so it is one of the materials that can be considered as a wrapping or cladding material.

However, the material properties of cork are too different from those of conventional injection molded garden hose nozzle, so it is not easy to combine with the nozzle body. Moreover, the material of cork is relatively hard and brittle, and there are still problems such as mold growth and peeling.

### SUMMARY OF THE INVENTION

This invention provides a gardening water spray gun, or called garden hose nozzle, to solve the above-mentioned deficiencies in the existing technology.

The present invention provides a garden hose nozzle, which includes a hose nozzle, wherein the hose nozzle is made of injection molding and has a body part, one end of the body part is connected to a water spray part for spraying water, the other end of the body part is equipped with a water supply part used to supply water. The surfaces of the body part, the water spray part, and the water supply part are covered with at least one wrapping layer for protection and holding. The wrapping layer is composed of a thermoplastic polyolefin, a polyethylene, and a cork. The proportions of the thermoplastic polyolefin, the polyethylene, and the cork in the wrapping layer are 15%, 54%, and 30% respectively.

Further, the wrapping layer includes a colorant, and the proportion of the colorant in the wrapping layer is 1%.

Further, the hose nozzle has a rotary handle for controlling water spray. The surface of the rotary handle is also covered with the wrapping layer, and the position of the rotary handle is at a point where the user can push the body part with his thumb.

The first purpose of this invention is that the wrapping layer has the characteristics of a composite material because it contains the thermoplastic polyolefin, the polyethylene, and the cork. The thermoplastic polyolefin and the polyethylene are polymers, so they have high plasticity during the molding process, and both are thermoplastic plastic materials, so they are better for recycling, reshaping, and reuse. The cork is a natural wood material, and can be completely recycled and reused. 99% of the components of the wrapping layer are recyclable, so it meets the requirements of having at least 70% post-consumer recycled content, and can achieve the effect of environmentally friendly recycling.

The second purpose of this invention is that the thermoplastic polyolefin and the polyethylene are both thermoplastic polymers, which have a low melting point and are easy to recycle and reuse. The polymers have high plasticity in the manufacturing process and can be easily formed the wrapping layer 101 for wrapping on the hose nozzle. The hose nozzle is also made of injection molding, and the material properties of the two are relatively close and easier to combine. It can improve the problem that the cork becomes moldy after being soaked and has poor ductility and is easily broken.

The third purpose of this invention is that the cork is a natural wood material. The material extraction process has a small impact on the environment and is renewable, so that is in line with the characteristics of sustainable use. The cork has the characteristics of being lightweight and can make the hose nozzle lighter, suitable for being held for a long time, and has a certain degree of elasticity, which can absorb the vibration of the hose nozzle when spraying water, and can reduce the vibration caused by the hose nozzle when held. The cork can also make the insulation properties of the wrapping layer better. The surface of the cork has a certain friction and has an anti-slip effect.

### BRIEF DESCRIPTION OF THE DRAWINGS

The following drawings are merely examples for illustrative purposes according to various disclosed embodiments and are not intended to limit the scope of the present disclosure.

FIG. 1 is a three-dimensional view of this invention.

FIG. 2 is an exploding view of this invention.

FIG. 3 is a front view of this invention.

FIG. 4 is a front cross-sectional view of the wrapping layer of this invention.

FIG. 5 is a schematic diagram of the composition of the wrapping layer of this invention.

### DETAILED DESCRIPTION OF THE INVENTION

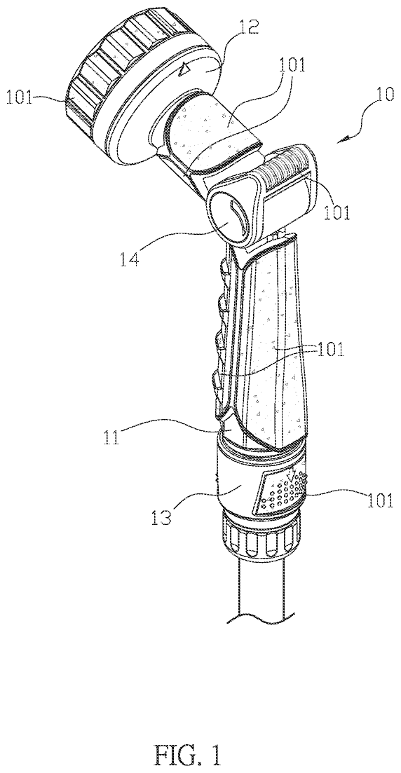

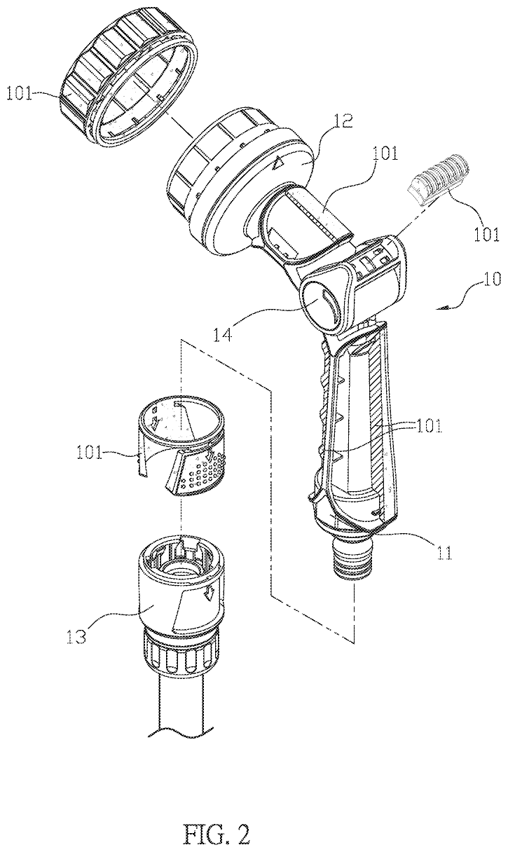

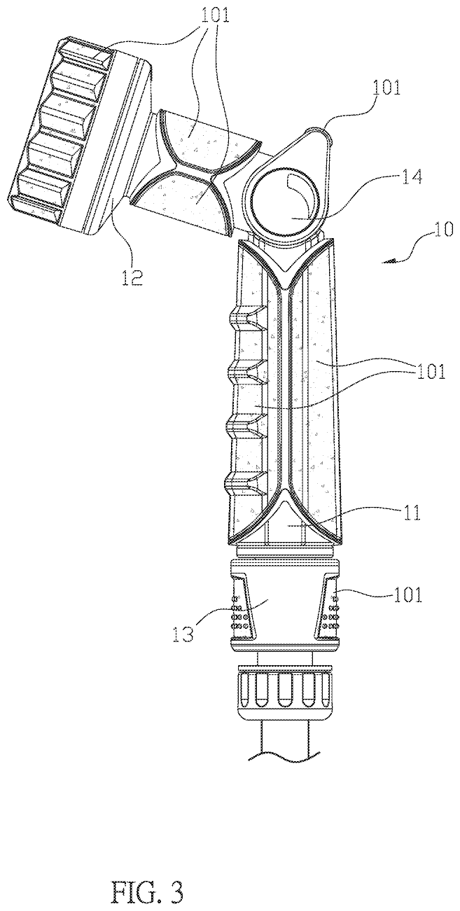

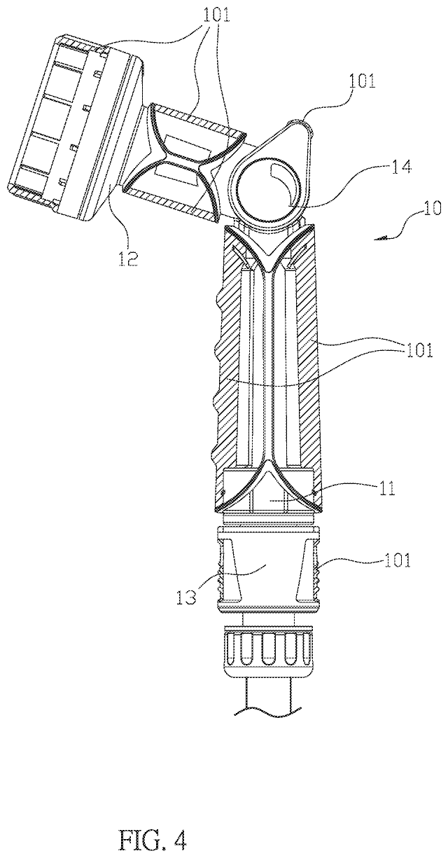

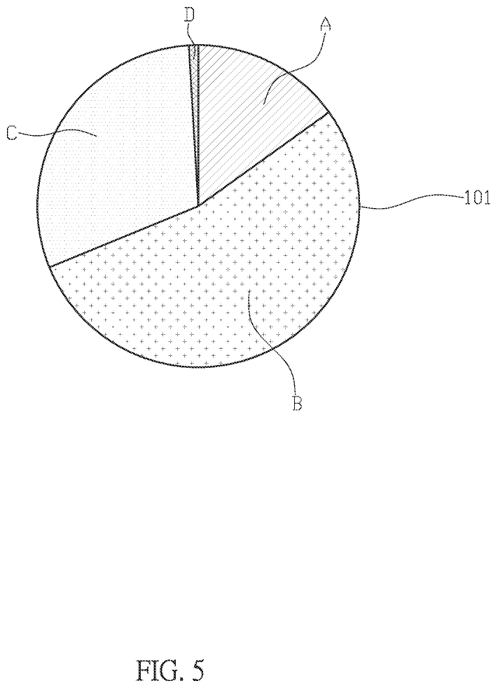

First, as shown in FIGS. 1-4, the present invention provides a garden hose nozzle, which includes a hose nozzle 10, wherein the hose nozzle 10 is made of injection molding and has a body part 11, one end of the body part 11 is connected to a water spray part 12 for spraying water, the other end of the body part 11 is equipped with a water supply part 13 used to supply water. The surfaces of the body part 11, the water spray part 12, and the water supply part 13 are covered with at least one wrapping layer 101 for protection and holding. As shown in FIG. 5, the wrapping layer 101 is composed of a thermoplastic polyolefin (A), a polyethylene (B), and a cork (C). The proportions of the thermoplastic polyolefin (A), the polyethylene (B), and the cork (C) in the wrapping layer 101 are 15%, 54%, and 30% respectively.

With the above structure, the wrapping layer 101 has the characteristics of a composite material because it contains the thermoplastic polyolefin (A), the polyethylene (B), and the cork (C). The thermoplastic polyolefin (A) and the polyethylene (B) are polymers, so they have high plasticity during the molding process, and both are thermoplastic plastic materials, so they are better for recycling, reshaping, and reuse. The cork (C) is a natural wood material, and can be completely recycled and reused. 99% of the components of the wrapping layer 101 are recyclable, so it meets the requirements of having at least 70% post-consumer recycled content, and can achieve the effect of environmentally friendly recycling.

Since the wrapping layer 101 has at least 70% post-consumer recycled content, it is ensured that it can comply with relevant environmental protection regulations of many countries to achieve the long-term vision of sustainability and environmental protection.

The thermoplastic polyolefin (A) and the polyethylene (B) are both thermoplastic polymers, which have a low melting point and are easy to recycle and reuse. The polymers have high plasticity in the manufacturing process and can be easily formed the wrapping layer 101 for wrapping on the hose nozzle 10. The hose nozzle 10 is also made of injection molding, and the material properties of the two are relatively close and easier to combine. It can improve the problems that the cork (C) becomes moldy after being soaked and has poor ductility and is easily broken.

The thermoplastic polyolefin (A) also has the property of not degrading under solar ultraviolet radiation, which can extend the service life of the hose nozzle 10 when working outdoors for a long time.

The proportion of polyethylene (B) in the wrapping layer 101 is 54%, which is the largest proportion. The polyethylene (B) has high strength, water resistance, oil resistance, acid resistance, alkali resistance, and corrosion-resistant properties so that can improve the service life and durability of the wrapping layer 101.

The cork (C) is a natural wood material. The material extraction process has a small impact on the environment and is renewable, so that is in line with the characteristics of sustainable use. The cork (C) has the characteristics of being lightweight and can make the hose nozzle 10 lighter, suitable for being held for a long time, and has a certain degree of elasticity, which can absorb the vibration of the hose nozzle 10 when spraying water, and can reduce the vibration caused by the hose nozzle 10 when held. The cork (C) can also make the insulation properties of the wrapping layer 101 better. The surface of the cork (C) has a certain friction and has an anti-slip effect.

Since the wrapping layer 101 is composed of the thermoplastic polyolefin (A), the polyethylene (B), and the cork (C), it has the benefits of a composite material and has the above-mentioned various advantages.

Moreover, the thermoplastic polyolefin (A) and the polyethylene (B) are both thermoplastic polymers, and the Poisson's ratio ranges between 0.1 and 0.5, that is, the volume changes greatly when under pressure, and the wrapping layer 101 of the hose nozzle 10 may fall off due to deformation. The Poisson's ratio of the cork (C) approaches 0, that is, the volume change is very small when under pressure. When the thermoplastic polyolefin (A), the polyethylene (B) and the cork (C) are mixed to reduce the Poisson's ratio, the wrapping layer 101 can withstand the volume change caused by the pressure. The wrapping layer 101 can be better combined with the surface of the hose nozzle 10 to prevent it from deforming and falling off.

As shown in FIG. 5, the present invention provides a garden hose nozzle, wherein the wrapping layer 101 further includes a colorant (D), and the proportion of the colorant (D) in the wrapping layer 101 is 1%, which can make the wrapping layer 101 more beautiful and also have a certain anti-corrosion effect.

As shown in FIGS. 1-4, the present invention provides a garden hose nozzle, wherein the hose nozzle 10 has a rotary handle 14 for controlling water spray. The surface of the rotary handle 14 is also covered with the wrapping layer 101, and the position of the rotary handle 14 is at a point where the user can push the body part 11 with his thumb.

What is claimed is:

1. A garden hose nozzle, comprising a hose nozzle, wherein:
the hose nozzle is made of injection molding and comprises a body part, one end of the body part is connected to a water spray part for spraying water, the other end of the body part is equipped with a water supply part used to supply water, the surfaces of the body part, the water spray part, and the water supply part are covered with at least one wrapping layer for protection and holding, the wrapping layer is composed of a thermoplastic polyolefin, a polyethylene, and a cork, the proportions of the thermoplastic polyolefin, the polyethylene, and the cork in the wrapping layer are 15%, 54%, and 30% respectively.

2. The garden hose nozzle of claim 1, wherein the wrapping layer further comprises a colorant, and the proportion of the colorant in the wrapping layer is 1%.

3. The garden hose nozzle of claim 1, wherein the hose nozzle comprises a rotary handle for controlling water spray, the surface of the rotary handle is also covered with the wrapping layer, and the position of the rotary handle is at a point where the user can push the body part with his thumb.
